(19) United States
(12) Patent Application Publication
(10) Pub. No.: US 2003/0115388 A1
(43) Pub. Date: Jun. 19, 2003

(54) Combined flash memory drive structure

(75) Inventors: Wen-Tsung Liu, HsinDian City (TW); Chia-Li Chen, HsinDian City (TW)

Correspondence Address: TROXELL LAW OFFICE PLLC, SUITE 1404, 5205 LEESBURG PIKE, FALLS CHURCH, VA, 22041, US

(73) Assignee: Carry Computer Eng., Inc.

(21) Appl. No.: 10/295,990

(22) Filed: Nov. 18, 2002

(30) Foreign Application Priority Data
Nov. 20, 2001 (TW) 090220035

(51) Int. Cl. G06F 13/12

(52) U.S. Cl. 710/62

(57) ABSTRACT

This invention provides a combined flash memory drive structure comprising an information processing module that can access one or more flash memory cards inserted in it at different times, a signal cable and an interface connector that connects said information processing module to a digital product, one or more sockets at one side of said flash memory drive. Said flash memory drive structure is characterised by: the bottom plate of it has a plurality of containing grooves, a cable containing groove, a cover plate, and a fastening shaft; said flash memory cards, said signal cable, and said interface connector can be placed in said containing grooves and covered with said cover plate through the coupling to said fastening shaft.

### DESCRIPTION OF THE INVENTION

This invention is related to a combined flash memory drive structure, in particular a flash memory structure that can access flash memory cards of different specifications at different times and host the signal cable in it.

With the quick devolvement of communication technologies and interconnected networks, people demands more on information exchange and processing, in particular on quick transmission of vast audio/video information. On the other hand, with the trend of globalization, working environments have been expanded far beyond offices to worldwide. More and more information is needed to support making decisions and taking activities. Hence, portable digital products, such as notebooks, personal digital assistants (PDAs), ebooks, DSCs, mobile phones, and mobile platforms, etc., are favored more and more by people. And devices designed to access above products are also demanded more and more.

Since 1990, flash memory developed on the basis of semiconductor storage technologies has become a new technology for storage media, and various flash memory cards (also referred as memory cards) (e.g., Smart Media Cards, Multimedia Cards, Memory Stick Cards, Secure Digital Cards, CompactFlash Cards (Type I and Type II) have been developed for new information appliances (lAs). Essentially, most above flash memory cards based on semiconductor storage technologies are far better than diskettes and CDs that are developed on the basis of legacy magnetic storage and optical storage technologies in size, power consumption, data preservation, data transmission speed, rewriting feature, and shockproof and damp-proof features.

However, most old flash memory drives only support corresponding flash memory cards because that flash memory cards from different vendors are different in size, electric specifications, communication protocols, and instructions. Currently, some universal flash memory drives that can access different flash memory cards have appeared in the market with the trend of diversification of flash memory cards. Most of those universal flash memory drives, however, utilize containing grooves that can host the largest flash memory cards (e.g., PC cards) available in the market, in order to be universal. Though those containing grooves can deal with some smaller flash memory cards (e.g., SD cards or MS cards), they are not ideal in locating and fixing those flash memory cards, and even cases of loosing, sliding out, or dropping off of flash memory cards may occur. Moreover, with the increasingly popularization of digital products, data access, data transmission, application (e.g., information stored in flash memory cards in DSCs can be printed out directly on digital printers), and even portability features of flash memory cards have become important considerations when customers decide to purchase flash memory card products.

In consideration of above problems, the inventor provides a combined flash memory drive structure, which can hide the signal cable to a digital product in it, i.e., the bottom plate has a plurality of containing grooves to host flash memory cards of different specifications and the signal cable, and then the bottom plate can be covered with a cover plate to enclose the flash memory cards and the signal cable in it. Such a design increases the portability of the flash memory drive and the interoperability to various digital products, overcoming some problems in legacy flash memory drives, such as exposure of signal cables and inconvenience in carrying (flash memory cards and flash memory drives have to be carried separately).

The features, functions, and advantages of the present invention will be readily understood upon a thoughtful deliberation of the following detailed description of the embodiments of the present invention with reference to the accompanying drawings:

### BRIEF DESCRIPTION OF THE DRAWINGS

FIG. 1 is a preferred embodiment implemented according to the present invention.

FIG. 2 is a 3D sketch map of a flash memory drive implemented according to the present invention with several flash memory cards of different specifications inserted in it.

FIG. 3 is a sketch map of the cable containing groove on the bottom plate and the interface connector.

FIG. 4 is another preferred embodiment implemented according to the present invention.

FIG. 5 is a sketch map of the bottom plate of the invention with several flash memory cards of different specifications and an interface connector placed in it.

FIG. 6 is a sketch map of the flash memory cards in FIG. 5.

FIG. 7 is a sketch map of the invention when a cover plated is applied.

### BRIEF DESCRIPTION OF THE SYMBOLS

100 Flash Memory Drive (Single Socket)

102, 214 SD Card, MMC Card

104, 212 MS Card

106, 210 SM Card

108 Containing Groove

110 Socket

112, 206 Cable Hole

114, 254 Cable Containing Groove

116, 250 Interface Connector

118 Salient Point

120, 208 Bottom Plate

200 Flash Memory Drive (Double Sockets)

202 First Socket

204 Second Socket

220 CF Card (Type I or Type II)

230 Cover Plate

232 Fastening Shaft

240 First Containing Groove

242 Second Containing Groove

244 Third Containing Groove

252 Forth Containing Groove

Description of the First Preferred Embodiment of the Present Invention

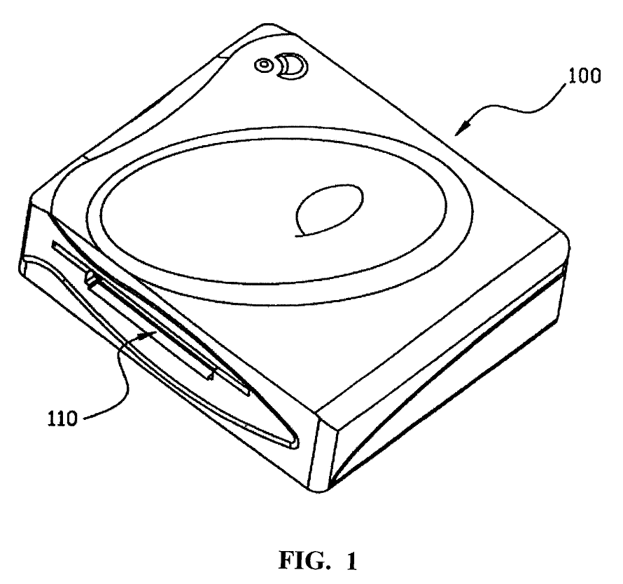

The inventor has applied patents for subject matter related with size, electric specification, communication protocol, connector, and instruction for various flash memory cards, and those patents are under substantive examination (see patent Ser. No. 90117605, 90118820, and 90214564). The circuit layouts of those patents will not be detailed introduced here. In other words, those technologies are common ones and not unique features of this invention. Please see FIG. 1, a preferred embodiment implemented according to this invention. The flash memory drive (100) in present invention is a rectangle in appearance. It has an information processing module (not shown in the figure) in it to access flash memory cards of different specifications inserted at different times.

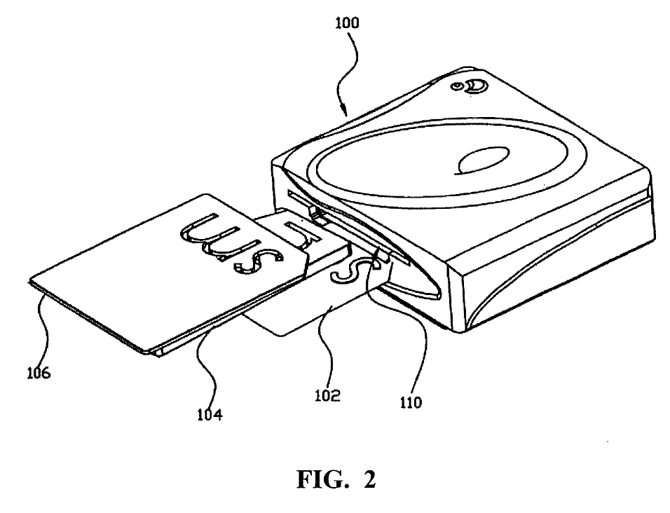

Please see also FIG. 2, a 3D sketch map of a flash memory drive implemented according to the present invention with several flash memory cards of different specifications inserted in it. The flash memory cards may include: Smart Media Card (106), Memory Stick Card (104), Multimedia Card or Secure Digital Card (102), each of them may be inserted in the socket (110). Furthermore, a flash memory drive that may support CompactFlash card (Type I or Type II) can also be implemented according to this invention. In other words, such flash memory cards (100) that have a single socket (110) can be further classified into two types to meet the requirements of customers. In short, the difference of the two types of single socket flash memory cards (100) lies in the interface (radial or axial).

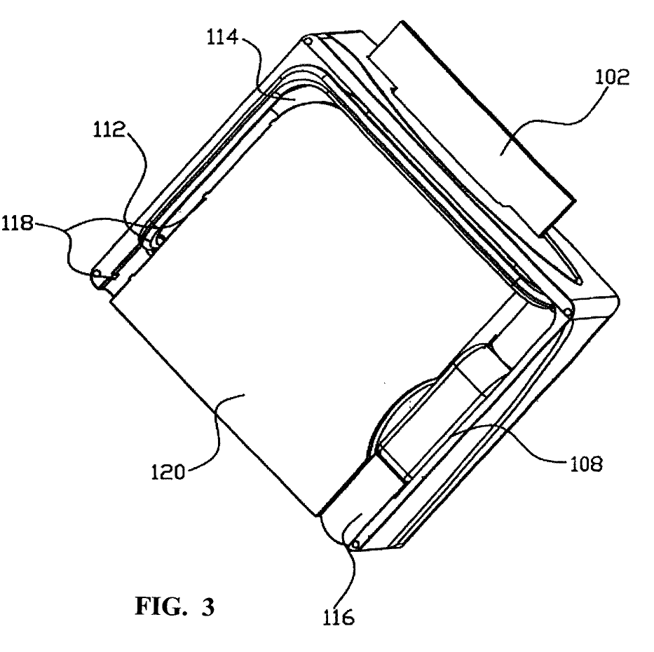

Please see also FIG. 3 at the same time, a sketch map of the cable containing groove on the bottom plate and the interface connector. The flash memory drive (100) in present invention can be connected to a digital product (not shown in the figure) via a signal cable (not shown) and an interface connector (116). Both of the signal cable and the interface connector are wrapped with a plastic sheath. The flash memory drive in present invention is featured with: the bottom plate (120) of it has a plurality of salient points (118), a cable hole (112), a cable containing groove (114), and a containing groove (108). The salient points (118) are around the cable containing groove (114). The signal cable runs out through the cable hole (112) and embedded in the cable containing groove (114) and the containing cable (108) along with the interface connector (116). Moreover, the signal cable can be fixed in the cable containing groove (114) with the salient points (118); while the interface connector (116) can be coupled with the containing groove.

It shall be noted that the interface connector (116) may be an IEEE1394 or USB. The signal cable (including the interface connector (116)) can be designed as a separated one, i.e., the signal cable can be separated from the flash memory drive and be attached with a connector at each end.

Description of Another Preferred Embodiment of the Present Invention

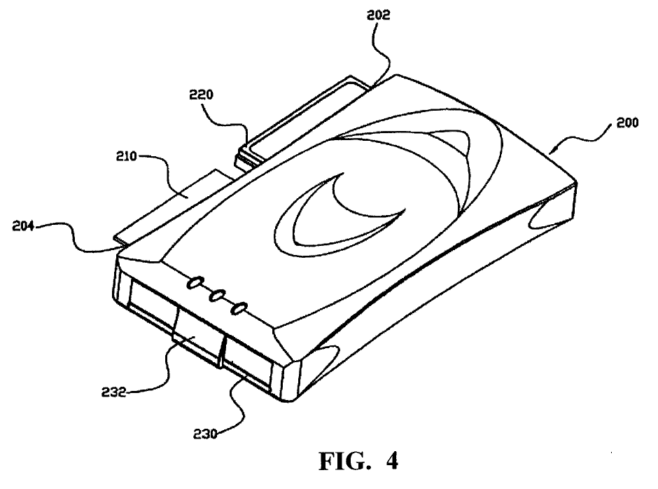

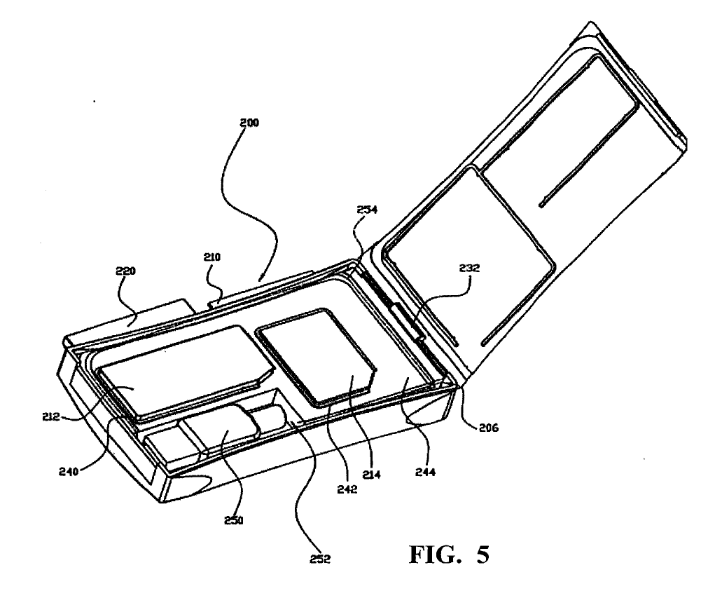

Please see FIG. 4, another preferred embodiment implemented according to the present invention. The flash memory drive (200) in FIG. 2 has two sockets (202, 204) and a cover plate (230) fastened with a fastening shaft (232). The current embodiment combines the two types of flash memory drives in embodiment 1 into a flash memory drive (200), i.e., the first socket (202) is designed to host a CF card (Type I or Type II) (220; while the second socket (204) is designed to host a SM card (210), a MS card (212), or a MMC card or SD card (214) (please see also FIG. 5). such a design adds value to the flash memory card and improves integrity.

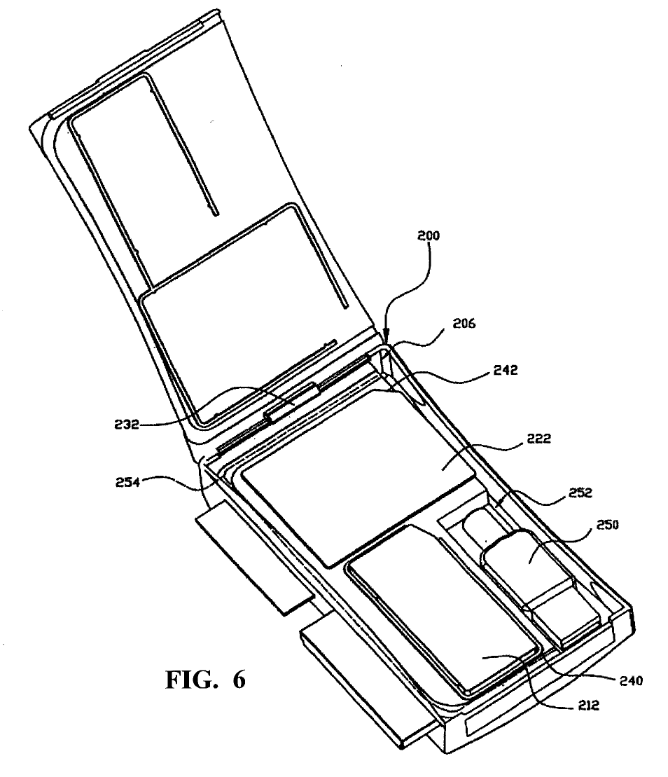

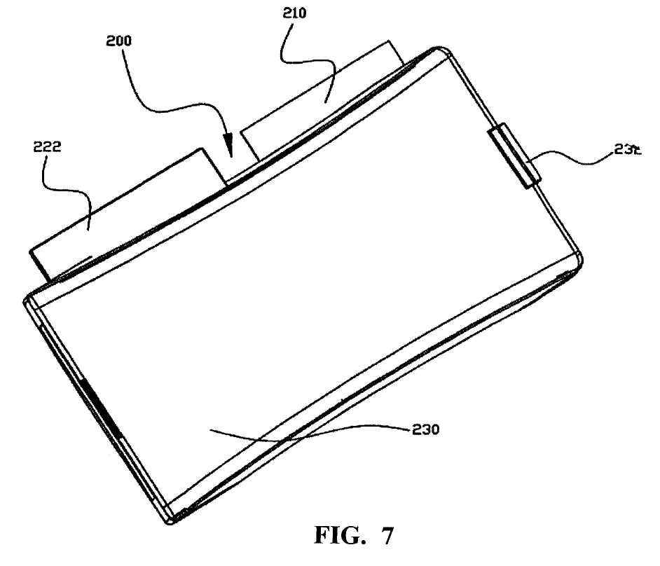

Please see FIG. 5 and FIG. 6, sketch map of the bottom plate of the invention with several flash memory cards of different specifications and an interface connector placed in it. The present invention is featured with: besides the structure in above embodiment (i.e., the signal cable runs out through the cable hole (206) and embedded in the cable containing groove (114) and the fourth containing cable (252) along with the interface connector (250), the bottom plate (208) of the flash memory drive (200) also has the first containing groove (240), the second containing groove (242), the third containing groove (244), and the fourth containing groove (252). Those containing grooves (240, 242, 244, and 252) are designed to host a MS card (212), a SD card or MMC card (214), a SM card (222), and the interface connector (250), respectively. In addition, the present embodiment has a cover plate (230) at one side of the bottom plate (208). Said cover plate (230) is fastened with a fastening shaft (232) to enclose the flash memory cards, the signal cable, and the interface connector (250) in the flash memory card (200) (as shown in FIG. 7).

It shall be noted that the interface connector in the present embodiment can also be an IEEE 1394 or USB, and the signal cable (including the interface connector (116) can also be designed as a separated one as in embodiment.

In conclusion, the inventor can hide the signal cable to a digital product in it, and the bottom plate has a plurality of containing grooves to host flash memory cards of different specifications and the signal cable, and then the bottom plate can be covered with a cover plate to enclose the flash memory cards and the signal cable in it. Such a design increases the portability of the flash memory drive and the interoperability to various digital products, overcoming some problems in legacy flash memory drives, such as exposure of signal cables and inconvenience in carrying (flash memory cards and flash memory drives have to be carried separately).

What is claimed is:

1. A combined flash memory drive structure comprising an information processing module that can access a flash memory cards inserted in it at different times, a signal cable and an interface connector that connects said information processing module to a digital product, a socket at one side of said flash memory drive; wherein said flash memory drive structure is featured with: the bottom plate of it has a plurality of containing grooves, a plurality of salient points, a cable containing groove, a cover plate, and a fastening shaft; said signal cable and said interface connector can be placed in said cable containing groove and containing grooves respectively, and said signal cable can be fixed with said salient points around said cable containing groove; said interface connector can be coupled with said containing grooves and located in them.

2. The combined flash memory drive structure of claim 1, wherein said interface connector is an USB connector.

3. The combined flash memory drive structure of claim 1, wherein said interface connector is an IEEE 1394 connector.

4. The combined flash memory drive structure of claim 1, wherein said signal cable can be designed as a separated one, i.e., the signal cable can be separated from the flash memory drive and be attached with a connector at each end (one connector is connected to said flash memory drive, and the other is connected to a digital product), and then be embedded in a containing groove.

5. The combined flash memory drive structure of claim 1, wherein said flash memory cards include a CF card (Type I).

6. The combined flash memory drive structure of claim 1, wherein said flash memory cards include a CF card (Type II).

7. The combined flash memory drive structure of claim 1, wherein said flash memory cards include a MS card.

8. The combined flash memory drive structure of claim 1, wherein said flash memory card include a SM card.

9. The combined flash memory drive structure of claim 1, wherein said flash memory card include a MMC card.

10. The combined flash memory drive structure of claim 1, wherein said flash memory card include a SD card.

11. A combined flash memory drive structure comprising an information processing module that can access one or more flash memory cards inserted in it at different times, a signal cable and an interface connector that connects said information processing module to a digital product, one or more sockets at one side of said flash memory drive; wherein said flash memory drive structure is featured with: the bottom plate of it has a plurality of containing grooves, a cable containing groove, a cover plate, and a fastening shaft; said flash memory card, said signal cable and said interface connector can be placed in said containing grooves, and said cover plate can be fastened with said fastening shaft.

12. The combined flash memory drive structure of claim 11, wherein said flash memory drive has 2 sockets.

13. The combined flash memory drive structure of claim 11, wherein said interface connector is a USB connector.

14. The combined flash memory drive structure of claim 11, wherein said signal cable can be designed as a separated one, i.e., the signal cable can be separated from the flash memory drive and be attached with a connector at each end (one connector is connected to said flash memory drive, and the other is connected to a digital product), and then be embedded in a containing groove.

15. The combined flash memory drive structure of claim 11, wherein said interface connector is an IEEE 1394 connector.

16. The combined flash memory drive structure of claim 11, wherein said flash memory cards include a CF card (Type I).

17. The combined flash memory drive structure of claim 11, wherein said flash memory cards include a CF card (Type II).

18. The combined flash memory drive structure of claim 11, wherein said flash memory cards include a MS card.

19. The combined flash memory drive structure of claim 11, wherein said flash memory card include a SM card.

20. The combined flash memory drive structure of claim 11, wherein said flash memory card include a MMC card.

21. The combined flash memory drive structure of claim 11, wherein said flash memory card include a SD card.
